(19) United States
(12) Patent Application Publication
(10) Pub. No.: US 2012/0208971 A1
(43) Pub. Date: Aug. 16, 2012

(54) METHOD FOR THE PRODUCTION OF HOMO- OR COPOLYMERS

(75) Inventors: Hannah Maria König, Mannheim (DE); Ingo Krossing, Freiburg Universitaet Freiburg (DE)

(73) Assignee: BASF SE, Ludwigshafen (DE)

(21) Appl. No.: 13/503,710

(22) PCT Filed: Nov. 2, 2010
(86) PCT No.: PCT/EP2010/066579

§ 371 Date: Apr. 24, 2012

(30) Foreign Application Priority Data
Nov. 4, 2009 (EP) 09174984.6

(51) Int. Cl. C08F 10/10

(52) U.S. Cl. 526/193

(57) ABSTRACT

Preparation of homo- or copolymers, especially of high-reactivity isobutene homo- or copolymers with a number-average molecular weight Mₙ of 400 to 1 000 000, by polymerizing one or more ethylenically unsaturated monomers in the liquid phase in the presence of a dissolved, dispersed or supported catalyst complex based on a protic acid compound obtainable by reacting a reactive inorganic or organic pentavalent phosphorus compound with three equivalents of an organic alpha,beta-dihydroxy compound, for example a tris(oxalato)- or tris(ortho-phenylenedioxy)phosphoric acid stabilized by a dialkyl ether.

The present invention relates to a process for preparing homo- or copolymers by polymerizing one or more ethylenically unsaturated monomers, especially for preparing high-reactivity isobutene homo- or copolymers with a number-average molecular weight Mₙ of 400 to 1 000 000 from isobutene or an isobutenic monomer mixture, in the liquid phase in the presence of a dissolved, dispersed or supported catalyst complex based on a phosphorus compound.

In contrast to so-called low-reactivity polymers, high-reactivity isobutene homo- or copolymers are understood to mean those polyisobutenes which comprise a high content of terminal ethylenic double bonds. In the context of the present invention, high-reactivity polyisobutenes shall be understood to mean those polyisobutenes which have a proportion of vinylidene double bonds (α-double bonds) of at least 60 mol %, preferably of at least 70 mol % and especially of at least 80 mol %, based on the polyisobutene macromolecules. In the context of the present application, vinylidene groups are understood to mean those double bonds whose position in the polyisobutene macromolecule is described by the general formula

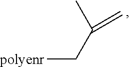

i.e. the double bond is present in the α position in the polymer chain. “Polymer” represents the polyisobutene radical shortened by one isobutene unit. The vinylidene groups exhibit the highest reactivity, whereas a double bond further toward the interior of the macromolecules exhibits no or in any case lower reactivity in functionalization reactions. The uses of high-reactivity polyisobutenes include use as intermediates for preparing additives for lubricants and fuels, as described, for example, in DE-A 27 02 604.

Such high-reactivity polyisobutenes are obtainable, for example, by the process of DE-A 27 02 604 by cationic polymerization of isobutene in the liquid phase in the presence of boron trifluoride as a catalyst. A disadvantage here is that the polyisobutenes obtained have a relatively high polydispersity. The polydispersity PDI is a measure of the molecular weight distribution of the resulting polymer chains and corresponds to the quotient of weight-average molecular weight M_{w} and number-average molecular weight Mₙ (PDI=M_{w}/Mₙ).

Polyisobutenes with a similarly high proportion of terminal double bonds but with a narrower molecular weight distribution are, for example, obtainable by the process of EP-A 145 235, U.S. Pat. No. 5,408,018 and WO 99/64482, the polymerization being effected in the presence of a deactivated catalyst, for example of a complex composed of boron trifluoride, alcohols and/or ethers. A disadvantage here is that it is necessary to work at very low temperatures, often significantly below 0° C., which causes high energy expenditure, in order to actually arrive at high-reactivity polyisobutenes.

It is known that catalyst systems as used, for example, in EP-A 145 235, U.S. Pat. No. 5,408,018 or WO 99/64482 lead to a certain residual fluorine content in the product in the form of organic fluorine compounds. In order to reduce the level of or to entirely avoid such by-products, boron trifluoride-containing catalyst complexes should be avoided.

DE-A 103 56 768 (1) describes salts of weakly coordinating anions which have boron, aluminum, gallium, indium, phosphorus, arsenic or antimony central atoms and comprise fluorine and alkoxide radicals, the preparation thereof and the use thereof for purposes including homogeneous catalysis, for example olefin polymerization. The counterions used are mono- or divalent cations, for example silver ions, tetrabutylammonium ions or cations obtained from fluorinated methane derivatives.

The literature article (2) with the title “Tris(oxalato)phosphorus Acid and Its Lithium Salts” by U. Wietelmann, W. Bonrath, T. Netscher, H. Nöth, J.-C. Panitz and M. Wohlfahrt-Mehrens in Chem. Eur. J. 2004, 10, 2451-2458, discloses reaction products of phosphorus pentachloride with in each case three equivalents of catechol (1,2-dihydroxybenzene) or oxalic acid (HOOC—COOH), which, after elimination of five equivalents of hydrogen chloride with abstraction of a proton, forms an anionic structure with oxygen hexacoordination to the phosphorus atom, the abstraction of the proton being stabilized by addition thereof onto a molecule of diethyl ether. The corresponding exact structures of these reaction products [tris(ortho-phenylenedioxy)-phosphoric acid and tris(oxalato)phosphoric acid] are reproduced in reaction equations (2) and (5) of document (2). Said reaction products are recommended as catalysts for Friedel-Crafts reactions and, in the form of lithium salts thereof, as electrolytes for nonaqueous batteries.

It was an object of the present invention to provide an improved polymerization process for the preparation of homo- or copolymers of ethylenically unsaturated monomers, especially for the preparation of high-reactivity isobutene homo- or copolymers with a number-average molecular weight Mₙ of 400 to 1 000 000, which preferably have a content of terminal vinylidene double bonds of at least 70 mol %, using a more suitable catalyst complex which serves as a polymerization catalyst. Such a process should firstly allow polymerization at not too low a temperature, but at the same time enable significantly shorter polymerization times.

The object was achieved by a process for preparing homo- or copolymers by polymerizing one or more ethylenically unsaturated monomers, especially for preparing high-reactivity isobutene homo- or copolymers with a number-average molecular weight Mₙ of 400 to 1 000 000, in the liquid phase in the presence of a dissolved, dispersed or supported catalyst complex, which comprises using, as the catalyst complex, a protic acid compound obtainable by reacting a reactive inorganic or organic pentavalent phosphorus compound with three equivalents of an organic alpha,beta-dihydroxy compound.

Reactive inorganic or organic pentavalent phosphorus compounds are understood to mean those compounds which permit conversion to a compound in which one phosphorus atom or the central phosphorus atom has the +5 oxidation state and is surrounded exclusively by oxygen atoms. In the case of a coordination number of 6, there is then generally an octahedral geometry, which is stable because it is symmetrical, with the phosphorus atom in the middle and the oxygen atoms at the vertices of the octahedron. The inorganic or organic pentavalent phosphorus compounds mentioned preferably comprise only one phosphorus atom. The pentavalent phosphorus compounds mentioned as reactants are preferably inorganic phosphorus compounds, particular preference being given here to phosphorus pentahalides such as phosphorus pentafluoride, phosphorus pentachloride, phosphorus pentabromide or phosphorus pentaiodide.

Examples of suitable organic alpha,beta-dihydroxy compounds are 1,2-diols such as glycol, 1,2-propanediol or similar dihydric alcohols, alpha-hydroxycarboxylic acids such as glycolic acid, lactic acid or mandelic acid, but especially 1,2-ethanedioic acid (oxalic acid) and 1,2-dihydroxy aromatic compounds such as catechol (1,2-dihydroxy-benzene), 1,2-dihydroxynaphthalene, 2,3-dihydroxynaphthalene and 2,3-dihydroxy-quinoxaline.

In a preferred embodiment of the process according to the invention, the catalyst complex used is a protic acid compound obtainable by reacting a phosphorus pentahalide with three equivalents of oxalic acid or with three equivalents of an unsubstituted or substituted catechol. Substituted catechols are, for example, 2,3- and 3,4-dihydroxytoluene, 2,3- and 3,4-dihydroxybenzyl alcohol, 2,3- and 3,4-dihydroxy-benzaldehyde, 2,3- and 3,4-dihydroxybenzoic acid, 2,3- and 3,4-dihydroxybenzoic esters, 2,3- and 3,4-dihydroxybenzamide, 2,3- and 3,4-dihydroxyhalobenzenes, 2,3- and 3,4-dihydroxybenzonitrile, 2,3- and 3,4-dihydroxynitrobenzene, 2,3- and 3,4-aceto-phenone and 2,3- and 3,4-dihydroxybenzophenone.

The reactive inorganic or organic pentavalent phosphorus compound is reacted with the organic alpha,beta-dihydroxy compound with elimination of the corresponding equivalents of a protonated leaving group; in the case of phosphorus pentachloride, this is, for example, five equivalents of hydrogen chloride.

A typical structure for the catalyst complexes of the present invention is the reaction product of a phosphorus pentahalide with 3 mol of oxalic acid with elimination of 5 mol of hydrogen halide [tris(oxalato)phosphoric acid]. The primary product formed is generally the structure I shown below:

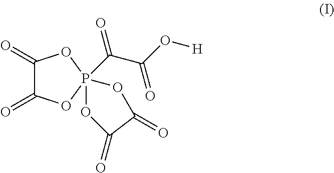

Such primary reaction products as the above structure form, typically with abstraction of a proton, an anionic structure with oxygen hexacoordination on the phosphorus atom, the abstraction of the one proton preferably being stabilized by addition thereof onto a suitable solvent molecule; such an anionic structure with oxygen hexacoordination on the phosphorus atom is reproduced by way of example hereinafter as structure II:

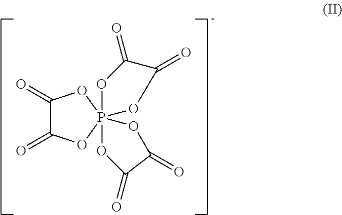

Suitable solvent molecules of this kind for stabilization of the protic acid compounds mentioned, which are obtainable by reaction of a reactive inorganic or organic pentavalent phosphorus compound with three equivalents of an organic alpha,beta-dihydroxyl compound, are especially cyclic and open-chain aliphatic ethers, especially tetrahydrofuran, tetrahydropyran (oxycyclohexane) or dioxane, and dialkyl ethers such as dimethyl ether, diethyl ether, dipropyl ether, diisopropyl ether, methyl ethyl ether, methyl n-propyl ether, methyl isopropyl ether, methyl tert-butyl ether or ethyl tert-butyl ether. It is also possible here to use oligo- and polyalkoxylenes and compounds with acetal or hemiacetal structures. In a preferred embodiment, one proton in the catalyst complex is stabilized by addition onto a dialkyl ether, and diethyl ether and methyl tert-butyl ether give the best results here.

Such solvent molecules suitable for stabilization, especially ethers, in particular dialkyl ethers and methyl tert-butyl ether, are typically used in one to six times and especially in one to four times the molar amount, based on the abstracted proton. However, it is also possible to dispense with the use of solvent molecules.

In a preferred embodiment, the catalyst complex used in the process according to the invention is tris(oxalato)phosphoric acid stabilized by a dialkyl ether.

In a further preferred embodiment, the catalyst complex used in the process according to the invention is tris(ortho-phenylenedioxy)phosphoric acid stabilized by a dialkyl ether.

Structures, analytical and spectroscopic data and preparation processes for tris(oxalato)phosphoric acid and tris(ortho-phenylenedioxy)phosphoric acid or for the diethyl ether complexes thereof are described in detail in document (2).

The process according to the invention can in principle be used to prepare homo- or copolymers of all conceivable ethylenically unsaturated monomers which are polymerizable under protic polymerization conditions. Examples thereof are linear alkenes such as ethene, propene, n-butene, n-pentene and n-hexene, alkadienes such as butadiene and isoprene, isoalkenes such as isobutene, 2-methylbutene-1,2-methylpentene-1,2-methylhexene-1,2-ethylpentene-1,2-ethylhexene-1 and 2-propylheptene-1, cycloalkenes such as cyclopentene and cyclohexene, aromatic alkenes such as styrene, α-methylstyrene, 2-, 3- and 4-methylstyrene and 4-tert-butylstyrene, and olefins which have a silyl group, such as 1-trimethoxysilylethene, 1-(trimethoxysilyl)propene, 1-(trimethoxysilyl)-2-methylpropene-2,1-[tri(methoxy-ethoxy)silyl]ethene, 1-[tri(methoxyethoxy)silyl]propene and 1-[tri(methoxyethoxy)silyl]-2-methylpropene-2. Mixtures of the monomers mentioned can of course also be used.

Preferred monomers are isobutene, isobutenic monomer mixtures such as C₄ hydrocarbon streams, styrene, styrenic monomer mixtures, styrene derivatives such as α-methylstyrene, the abovementioned cycloalkenes, the abovementioned alkadienes and mixtures thereof.

Particularly preferred monomers are isobutene, isobutenic monomer mixtures such as C₄ hydrocarbon streams, styrene, styrenic monomer mixtures and mixtures thereof.

The homo- and copolymers prepared by the process according to the invention generally have number-average molecular weights Mₙ of 400 to 5 000 000, preferably of 400 to 1 000 000, especially of 400 to 500 000 and in particular of 400 to 250 000.

The copolymers prepared by the process according to the invention may be random polymers or block copolymers.

The polymerization to give the abovementioned homo- or copolymers can be performed either continuously or batchwise.

In a preferred embodiment, the process according to the invention is used to prepare high-reactivity isobutene homo- or copolymers with a number-average molecular weight Mₙ of 500 to 1 000 000 from isobutene or an isobutenic monomer mixture.

In the context of the present invention, isobutene homopolymers are understood to mean those polymers which, based on the polymer, are formed from isobutene to an extent of at least 98 mol %, preferably to an extent of at least 99 mol %. Accordingly, isobutene copolymers are understood to mean those polymers which comprise more than 2 mol % of copolymerized monomers other than isobutene.

The process according to the invention is thus suitable for preparing low, medium and high molecular weight, high-reactivity isobutene homo- or copolymers. Preferred comonomers here are styrene, styrene derivatives such as especially α-methylstyrene and 4-methylstyrene, monomer mixtures comprising styrene and styrene derivatives, alkadienes such as butadiene and isoprene, and mixtures thereof.

For the use of isobutene or of an isobutenic monomer mixture as the monomer material to be polymerized, suitable isobutene sources are both isobutene itself and isobutenic C₄ hydrocarbon streams, for example C₄ raffinates such as raffinate I, C₄ cuts from isobutane dehydrogenation, C₄ cuts from steam crackers and from FCC crackers (fluid catalyzed cracking), provided that they have been substantially freed of 1,3-butadiene present therein. Suitable C₄ hydrocarbon streams generally comprise less than 500 ppm, preferably less than 200 ppm, of butadiene. The presence of 1-butene and of cis- and trans-2-butene is substantially uncritical. Typically, the isobutene concentration in the C₄ hydrocarbon streams is in the range from 40 to 60% by weight. The isobutenic monomer mixture may comprise small amounts of contaminants such as water, carboxylic acids or mineral acids, without there being any critical yield or selectivity losses. It is appropriate to prevent enrichment of these impurities by removing such harmful substances from the isobutenic monomer mixture, for example by adsorption on solid adsorbents such as activated carbon, molecular sieves or ion exchangers.

It is possible to convert monomer mixtures of isobutene or of the isobutenic hydrocarbon mixture with olefinically unsaturated monomers copolymerizable with isobutene. When monomer mixtures of isobutene are to be copolymerized with suitable comonomers, the monomer mixture preferably comprises at least 5% by weight, more preferably at least 10% by weight and especially at least 20% by weight of isobutene, and preferably at most 95% by weight, more preferably at most 90% by weight and especially at most 80% by weight of comonomers.

Useful copolymerizable monomers include: vinylaromatics such as styrene and α-methylstyrene, C₁-C₄-alkylstyrenes such as 2-, 3- and 4-methylstyrene, and also 4-tert-butylstyrene, alkadienes such as butadiene and isoprene, and isoolefins having 5 to 10 carbon atoms, such as 2-methylbutene-1,2-methylpentene-1,2-methylhexene-1,2-ethylpentene-1,2-ethylhexene-1 and 2-propylheptene-1. Further useful comonomers include olefins which have a silyl group, such as 1-trimethoxysilylethene, 1-(trimethoxysilyl)propene, 1-(trimethoxysilyl)-2-methylpropene-2,1-[tri-(methoxyethoxy)silyl]ethene, 1-[tri(methoxyethoxy)silyl]propene, and 1-[tri(methoxy-ethoxy)silyl]-2-methylpropene-2, and also vinyl ethers such as tert-butyl vinyl ether.

When the process according to the invention is to be used to prepare copolymers, the process can be configured so as to preferentially form random polymers or to preferentially form block copolymers. To prepare block copolymers, for example, the different monomers can be supplied successively to the polymerization reaction, in which case the second comonomer is especially not added until the first comonomer is already at least partly polymerized. In this manner, diblock, triblock and higher block copolymers are obtainable, which, according to the sequence of monomer addition, have a block of one or the other comonomer as a terminal block. In some cases, however, block copolymers also form when all comonomers are supplied to the polymerization reaction simultaneously, but one of them polymerizes significantly more rapidly than the other(s). This is the case especially when isobutene and a vinylaromatic compound, especially styrene, are copolymerized in the process according to the invention. This preferably forms block copolymers with a terminal polyisobutene block. This is attributable to the fact that the vinylaromatic compound, especially styrene, polymerizes significantly more rapidly than isobutene.

The polymerization can be effected either continuously or batchwise. Continuous processes can be performed in analogy to known prior art processes for continuous polymerization of isobutene in the presence of Lewis acid catalysts in the liquid phase.

The process according to the invention is suitable both for performance at low temperatures, e.g. at −78 to 0° C., and at higher temperatures, i.e. at at least 0° C., e.g. at 0 to 100° C. For economic reasons in particular, the polymerization is preferably performed at least 0° C., e.g. at 0 to 100° C., more preferably at 20 to 60° C., in order to minimize the energy and material consumption required for cooling. It can, however, be performed just as efficiently at lower temperatures, e.g. at −78 to <0° C., preferably at −60 to −10° C. A temperature range usable in practice is at least −60° C., for example −60 to +40° C., especially −45 to +25° C.

When the polymerization is effected at or above the boiling temperature of the monomer or monomer mixture to be polymerized, it is preferably performed in pressure vessels, for example in autoclaves or in pressure reactors.

The polymerization is preferably performed in the presence of an inert diluent. The inert diluent used should be suitable for reducing the increase in the viscosity of the reaction solution which generally occurs during the polymerization reaction to such an extent that the removal of the heat of reaction which evolves can be ensured. Suitable diluents are those solvents or solvent mixtures which are inert toward the reagents used. Suitable diluents are, for example, aliphatic hydrocarbons such as butane, pentane, hexane, heptane, octane and isooctane, cycloaliphatic hydrocarbons such as cyclopentane and cyclohexane, aromatic hydrocarbons such as benzene, toluene and the xylenes, and halogenated hydrocarbons such as methyl chloride, dichloromethane and trichloromethane, and mixtures of the aforementioned diluents. Preference is given to using at least one halogenated hydrocarbon, optionally in a mixture with at least one of the aforementioned aliphatic or aromatic hydrocarbons. In particular, dichloromethane is used. Another inert diluent which has been found to be very particularly useful for the polymerization is a mixture of toluene and dichloromethane. Before use, the diluents are preferably freed of impurities such as water, carboxylic acids or mineral acids, for example by adsorption on solid adsorbents such as activated carbon, molecular sieves or ion exchangers.

The polymerization is preferably performed under substantially aprotic and especially under anhydrous reaction conditions. Aprotic and anhydrous reaction conditions are understood to mean that, respectively, the content of protic impurities and the water content in the reaction mixture are less than 50 ppm and especially less than 5 ppm. In general, the feedstocks will therefore be dried before use by physical and/or chemical measures. More particularly, it has been found to be useful to admix the aliphatic or alicyclic hydrocarbons used as solvents, after customary prepurification and predrying with an organometallic compound, for example an organolithium, organomagnesium or organoaluminum compound, in an amount which is sufficient to remove the water traces from the solvent. The solvent thus treated is then preferably condensed directly into the reaction vessel. It is also possible to proceed in a similar manner with the monomers to be polymerized, especially with isobutene or with the isobutenic mixtures. Drying with other customary desiccants such as molecular sieves or predried oxides such as aluminum oxide, silicon dioxide, calcium oxide or barium oxide is also suitable. The halogenated solvents for which drying with metals such as sodium or potassium or with metal alkyls is not an option are freed of water (traces) with desiccants suitable for that purpose, for example with calcium chloride, phosphorus pentoxide or molecular sieves. It is also possible in an analogous manner to dry those feedstocks for which treatment with metal alkyls is likewise not an option, for example vinylaromatic compounds.

The polymerization of the isobutene or of the isobutenic starting material generally proceeds spontaneously when the catalyst complex is contacted with the monomer at the desired reaction temperature. The procedure here may be to initially charge the monomer, optionally in the solvent, to bring it to reaction temperature and then to add the catalyst complex, for example as a loose bed. The procedure may also be to initially charge the catalyst complex (for example as a loose bed or as a fixed bed), optionally in the solvent, and then to add the monomer. The start of polymerization is then considered to be that time at which all reactants are present in the reaction vessel. The catalyst complex may dissolve partly or fully in the reaction medium or be present as a dispersion. Alternatively, the catalyst complex may also be used in supported form.

If the catalyst complex is to be used in supported form, it is contacted with a suitable support material and thus converted to a heterogenized form. The contacting is effected, for example, by impregnation, saturation, spraying, brushing or related techniques. The contacting also comprises techniques of physisorption. The contacting can be effected at standard temperature and standard pressure, or else at higher temperatures and/or pressures. As a result of the contacting, the catalyst complex enters into physical and/or chemical interactions, usually electrostatic interactions, with the support material.

Other essential factors for suitability as a support material in the context of the present invention are the specific surface size thereof and the porosity properties thereof. In this context, mesoporous support materials have been found to be particularly advantageous. Mesoporous support materials generally have an internal surface area of 100 to 3000 m²/g, especially 200 to 2500 m²/g, and pore diameters of 0.5 to 50 nm, especially of 1 to 20 nm.

Suitable support materials are in principle all solid inert substances with a large surface area, which may typically serve as a substrate or skeleton for active ingredient, especially for catalysts. Typical inorganic substance classes for such support materials are activated carbon, alumina, silica gel, kieselguhr, talc, kaolin, clays and silicates. Typical organic substance classes for such support materials are crosslinked polymer matrices such as crosslinked polystyrenes and crosslinked polymethacrylates, phenol-formaldehyde resins or polyalkylamine resins.

The support material is preferably selected from molecular sieves and ion exchangers.

The ion exchangers used may be cation exchangers, anion exchangers or amphoteric ion exchangers. Preferred organic or inorganic matrix types for such ion exchangers here are divinylbenzene-wetted polystyrenes (crosslinked divinylbenzene-styrene copolymers), divinylbenzene-crosslinked polymethacrylates, phenol-formaldehyde resins, polyalkylamine resins, hydrophilized cellulose, crosslinked dextran, crosslinked agarose, zeolites, montmorillonites, attapulgites, bentonites, aluminum silicates and acidic salts of polyvalent metal ions, such as zirconium phosphate, titanium tungstate or nickel hexacyanoferrate(II). Acidic ion exchangers typically bear carboxylic acid, phosphonic acid, sulfonic acid, carboxymethyl or sulfoethyl groups. Basic ion exchangers usually comprise primary, secondary or tertiary amino groups, quaternary ammonium groups, aminoethyl groups or diethylaminoethyl groups.

Molecular sieves have a strong adsorption capacity for gases, vapors and dissolved substances, and are generally also useable for ion exchange operations. Molecular sieves generally have homogeneous pore diameters within the order of magnitude of the diameter of molecules, and large internal surface areas, typically 600 to 700 m²/g. The molecular sieves used in the context of the present invention may especially be silicates, aluminum silicates, zeolites, silicoalumophosphates and/or carbon molecular sieves.

Ion exchangers and molecular sieves having an internal surface area of 100 to 3000 m²/g, especially 200 to 2500 m²/g, and pore diameters of 0.5 to 50 nm, especially of 1 to 20 nm, are particularly advantageous.

The support material is preferably selected from molecular sieves of the H-AIMCM-41, H-AIMCM-48, NaAIMCM-41 and NaAIMCM-48 types. These molecular sieve types are silicates or aluminum silicates on whose inner surface area silanol groups adhere, which may be of significance for the interaction with the catalyst complex. The interaction is probably based, however, principally on the partial exchange of protons.

When used as a solution, as a dispersion or in supported form, the catalyst complex active as a polymerization catalyst is used in such an amount that it, based on the amounts of monomers used, is present in the polymerization medium in a molar ratio of preferably 1:10 to 1:1 000 000, in particular of 1:50 to 1:500 000 and especially 1:100 to 1:100 000.

The concentration (“loading”) of the catalyst complex in the support material is in the range from preferably 0.005 to 20% by weight, in particular 0.01 to 10% by weight and especially 0.1 to 5% by weight.

The catalyst complex active as a polymerization catalyst is present in the polymerization medium, for example, as a loose bed, as a fluidized bed, as a fluid bed or as a fixed bed. Suitable reactor types for the polymerization process according to the invention are accordingly typically stirred tank reactors, loop reactors, tubular reactors, fluidized bed reactors, stirred tank reactors with and without solvent, fluid bed reactors, continuous fixed bed reactors and batchwise fixed bed reactors (batchwise mode).

To prepare copolymers, the procedure may be to initially charge the monomers, optionally in the solvent, and then to add the catalyst complex, for example as a loose bed. The reaction temperature can be established before or after the addition of the catalyst complex. The procedure may also be first to initially charge only one of the monomers, optionally in the solvent, then to add the catalyst complex and to add the further monomer(s) only after a certain time, for example when at least 60%, at least 80% or at least 90% of the monomer has been converted. Alternatively, the catalyst complex can be initially charged, for example as a loose bed, optionally in the solvent, then the monomers can be added simultaneously or successively, and then the desired reaction temperature can be established. The start of polymerization is then considered to be that time at which the catalyst complex and at least one of the monomers are present in the reaction vessel.

In addition to the batchwise procedure described here, the polymerization can also be configured as a continuous process. In this case, the feedstocks, i.e. the monomer(s) to be polymerized, if appropriate the solvent and if appropriate the catalyst complex (for example as a loose bed) are supplied continuously to the polymerization reaction, and reaction product is withdrawn continuously, such that more or less steady-state polymerization conditions are established in the reactor. The monomer(s) to be polymerized can be supplied as such, diluted with a solvent or as a monomer-containing hydrocarbon stream.

To stop the reaction, the reaction mixture is preferably deactivated, for example by adding a protic compound, especially by adding water, alcohols such as methanol, ethanol, n-propanol and isopropanol or mixtures thereof with water, or by adding an aqueous base, for example an aqueous solution of an alkali metal or alkaline earth metal hydroxide such as sodium hydroxide, potassium hydroxide, magnesium hydroxide or calcium hydroxide, an alkali metal or alkaline earth metal carbonate such as sodium, potassium, magnesium or calcium carbonate, or an alkali metal or alkaline earth metal hydrogencarbonate such as sodium, potassium, magnesium or calcium hydrogencarbonate.

In a preferred embodiment of the invention, the process according to the invention serves to prepare high-reactivity isobutene homo- or copolymers with a content of terminal vinylidene double bonds (α-double bonds) of at least 70 mol %, preferably of at least 80 mol %, more preferably of at least 85 mol % and especially of at least 90 mol %, for example of about 95 mol % or of 100 mol %. More particularly, it serves to prepare high-reactivity copolymers which are formed from monomers comprising isobutene and at least one vinylaromatic compound and a content of terminal vinylidene double bonds (α-double bonds) of at least 70 mol %, preferably of at least 80 mol %, more preferably of at least 85 mol % and especially of at least 90 mol %, for example of about 95 mol % or of 100 mol %.

The copolymerization of isobutene or isobutenic hydrocarbon cuts with at least one vinylaromatic compound also forms, in the case of simultaneous addition of the comonomers, preferably block copolymers, the isobutene block generally constituting the terminal block, i.e. the block formed last.

Accordingly, the process according to the invention, in a preferred embodiment, serves to prepare high-reactivity isobutene-styrene copolymers. The high-reactivity isobutene-styrene copolymers preferably have a content of terminal vinylidene double bonds (α-double bonds) of at least 70 mol %, more preferably of at least 80 mol %, even more preferably of at least 85 mol % and especially of at least 90 mol %, for example of about 95 mol % or of 100 mol %.

To prepare such copolymers, isobutene or an isobutenic hydrocarbon cut is copolymerized with at least one vinylaromatic compound, especially styrene. More preferably, such a monomer mixture comprises 5 to 95% by weight and more preferably 30 to 70% by weight of styrene.

The high-reactivity isobutene homo- or copolymers prepared by the process according to the invention, specifically the isobutene homopolymers, preferably have a polydispersity (PDI=M_{w}/Mₙ) of 1.0 to 4.0, in particular of at most 3.0, preferably of 1.0 to 2.5, more preferably of 1.0 to 2.0 and especially of 1.0 to 1.5.

The high-reactivity isobutene homo- or copolymers prepared by the process according to the invention preferably possess a number-average molecular weight Mₙ of 400 to 1 000 000, more preferably of 400 to 50 000, even more preferably of 400 to 5000 and especially of 400 to 3000. Isobutene homopolymers specifically even more preferably possess a number-average molecular weight Mₙ of 400 to 50 000 and especially of 400 to 5000, for example of about 1000 or of about 2300.

The process according to the invention successfully polymerizes ethylenically unsaturated monomers, especially isobutene and isobutenic monomer mixtures, which are polymerizable under protic polymerization conditions with high conversions in short reaction times even at relatively high polymerization temperatures. This additionally affords high-reactivity isobutene homo- or copolymers with a high content of terminal vinylidene double bonds and with quite a narrow molecular weight distribution. The use of fluorine-free compounds as polymerization catalysts causes less wastewater and environmental pollution.

The examples which follow illustrate the present invention in detail without restricting it.

### EXAMPLES 1 TO 4

The amounts of the tris(oxalato)phosphoric acid catalyst complex of the formula [(Et₂O)₂H]⁺[P(C₂O₄)₃], stabilized with twice the molar amount of diethyl ether, specified in the table appended below were each dissolved in 50 ml of the diluent specified and initially charged in a glass autoclave at a temperature of −60° C. Subsequently, 3.91 g (70 mmol) of isobutene were condensed into each glass autoclave. The temperature was adjusted to the value specified in each case. After 30 minutes of reaction time at this temperature, the polymerization was stopped by adding isopropanol. The organic phase was washed with water, dried over magnesium sulfate and then concentrated under reduced pressure. The table appended below shows the results of the reactions.

| Example No. | 1 | 2 | 3 | 4 |
|---|---|---|---|---|
| Reaction temperature [° C.] | 30 | 20 | −30 | −60 |
| Diluent | hexane | toluene | CH₂Cl₂ | CH₂Cl₂ |
| Amount of catalyst [mg] | 200 | 200 | 100 | 100 |
| Conversion [%] | 32 | 40 | 90 | 100 |
| Content of terminal vinylidene | 77.7 | 72.2 | 88.2 | 93.9 |
| double bonds [mol %] | | | | |
| Weight-average molecular | 766 | 560 | 2297 | 10744 |
| weight M_{w} | | | | |
| Number-average molecular | 516 | 403 | 1151 | 2990 |
| weight Mₙ | | | | |
| Polydispersity (PDI) | 1.48 | 1.39 | 2.00 | 3.59 |

### EXAMPLE 5

The amount specified in the table appended below of the tris(oxalato)phosphoric acid of the formula P(C₂O₄)₂(C₂O₄H) unstabilized by a dialkyl ether was dissolved in 50 ml of the diluent specified and initially charged in a glass autoclave at a temperature of −60° C. Subsequently, 6.26 g of a raffinate I hydrocarbon stream which comprised 48% by weight of isobutene, corresponding to 3.0 g (54 mmol) of isobutene, were condensed into the glass autoclave. The temperature was adjusted to the value specified. After a reaction time of 30 minutes at this temperature, the polymerization was stopped by adding isopropanol. The organic phase was washed with water, dried over magnesium sulfate and then concentrated under reduced pressure. The table appended below shows the results of the reactions.

| Example No. | 5 |
|---|---|
| Reaction temperature [° C.] | −60 |
| Diluent | CH₂Cl₂ |
| Amount of catalyst [mg] | 100 |
| Conversion [%] | 86 |
| Content of terminal vinylidene double bonds [mol %] | 84.3 |
| Weight-average molecular weight M_{w} | 7625 |
| Number-average molecular weight Mₙ | 2052 |
| Polydispersity (PDI) | 3.72 |

### EXAMPLE 6

The amount specified in the table appended below of the tris(oxalato)phosphoric acid catalyst complex of the formula [(Et₂O)₂H]⁺[P(C₂O₄)₃]⁻.2 Et₂O admixed with four times the molar amount of diethyl ether was dissolved in 50 ml of the diluent specified and initially charged in a glass autoclave at a temperature of −60° C. Thereafter, 6.26 g (112 mmol) of isobutene were condensed into the glass autoclave. The temperature was adjusted to the value specified. After 30 minutes of reaction time at this temperature, the polymerization was stopped by adding isopropanol. The organic phase was washed with water, dried over magnesium sulfate and then concentrated under reduced pressure. The table appended below shows the results of the reactions.

| Example No. | 6 |
|---|---|
| Reaction temperature [° C.] | 0 |
| Diluent | toluene |
| Amount of catalyst [mg] | 500 |
| Conversion [%] | 62 |
| Content of terminal vinylidene double bonds [mol %] | 87.2 |
| Weight-average molecular weight M_{w} | 881 |
| Number-average molecular weight Mₙ | 552 |
| Polydispersity (PDI) | 1.60 |

### EXAMPLE 7

The amount specified in the table appended below of the tris(oxalato)phosphoric acid catalyst complex of the formula [(Et₂O)₁H]⁺[P(C₂O₄)₃]⁻ stabilized by the equimolar amount of diethyl ether was dissolved in 50 ml of the diluent specified and initially charged in a glass autoclave at a temperature of −60° C. Subsequently, 6.26 g of a raffinate I hydrocarbon stream which comprised 48% by weight of isobutene, corresponding to 3.0 g (54 mmol) of isobutene, were condensed into the glass autoclave. The temperature was adjusted to the value specified. After 30 minutes of reaction time at this temperature, the polymerization was stopped by adding isopropanol. The organic phase was washed with water, dried over magnesium sulfate and then concentrated under reduced pressure. The table appended below shows the results of the reactions.

| Example No. | 7 |
|---|---|
| Reaction temperature [° C.] | −30 |
| Diluent | CH₂Cl₂ |
| Amount of catalyst [mg] | 100 |
| Conversion [%] | 90 |
| Content of terminal vinylidene double bonds [mol %] | 91.0 |
| Weight-average molecular weight M_{w} | 2297 |
| Number-average molecular weight Mₙ | 1151 |
| Polydispersity (PDI) | 2.00 |

1: A process for preparing a homo- or copolymer, the process comprising polymerizing one or more ethylenically unsaturated monomers in the liquid phase in the presence of a dissolved, dispersed or supported catalyst complex comprising a protic acid compound obtained by reacting an inorganic or organic pentavalent phosphorus compound with three equivalents of an organic alpha,beta-dihydroxy compound.

2: The process of claim 1, wherein the catalyst complex is a protic acid compound obtained by reacting a phosphorus pentahalide with three equivalents of oxalic acid or with three equivalents of an unsubstituted or substituted catechol.

3: The process of claim 1, wherein one proton in the catalyst complex is stabilized by addition onto a dialkyl ether.

4: The process of claim 1, wherein the catalyst complex is tris(oxalato)phosphoric acid stabilized by a dialkyl ether.

5: The process of claim 1, wherein the catalyst complex is a tris(ortho-phenylenedioxy)phosphoric acid stabilized by a dialkyl ether.

6: The process of claim 1, wherein the process provides at least one high-reactivity isobutene homo- or copolymer with a number-average molecular weight Mₙ of 400 to 1 000 000 from isobutene or an isobutenic monomer mixture.

7: The process of claim 6, wherein the at least one high-reactivity isobutene homo- or copolymer has content of terminal vinylidene double bonds of at least 70 mol %.

8: The process of claim 6, wherein the at least one high-reactivity isobutene homo- or copolymer has a polydispersity of 1.0 to 4.0.
